(19) United States
(12) Patent Application Publication
(10) Pub. No.: US 2026/0288118 A1
(43) Pub. Date: Sep. 24, 2026

(54) SEMI-STANDARD-BASED EQUIPMENT DATA COLLECTION ARCHITECTURE AND SUPPORT DEVICE THEREFOR

(71) Applicant: DOOPLE INC., Seongnam-si, Gyeonggi-do (KR)

(72) Inventor: Hyung Su KIM, Yongin-si, Gyeonggi-do (KR)

(73) Assignee: DOOPLE INC., Seongnam-si, Gyeonggi-do (KR)

(21) Appl. No.: 19/129,718

(22) PCT Filed: Aug. 22, 2023
(86) PCT No.: PCT/KR2023/012403

§ 371 Date: May 21, 2026

(30) Foreign Application Priority Data
Nov. 16, 2022 (KR) 10-2022-0153160
Nov. 16, 2022 (KR) 10-2022-0153161
Nov. 16, 2022 (KR) 10-2022-0153162
Nov. 16, 2022 (KR) 10-2022-0153163

(51) Int. Cl. G05B 19/418; G06F 21/60

(52) U.S. Cl. CPC G05B 19/4183; G06F 21/604; G06F 2221/2141

(57) ABSTRACT

An equipment data acquisition support device includes a plurality of interfaces including a first interface for receiving a command from a user terminal and responding to the received command, and a second interface for transmitting a command to semiconductor equipment and receiving a response according to the command according to the equipment data acquisition (EDA) standards, a metadata management unit that provides access to metadata of the semiconductor equipment to the user terminal, a security management unit that provides access to an access control list (ACL) comprising access privilege information for the semiconductor equipment to the user terminal, a session management unit that provides a session connection based on the access control list to the user terminal, and a data collection plan management unit that provides access to a a data collection plan (DCP) of the semiconductor equipment defined based on the metadata to the user terminal.

### TECHNICAL FIELD

The present disclosure relates to a SEMI standard-based equipment data acquisition architecture and a support device therefor, and more particularly, to an architecture that allows a user to manage an entire process of acquiring data from semiconductor equipment according to the SEMI standards, and a support device therefor.

### BACKGROUND ART

The statements in this section merely provide background information related to one embodiment of the present disclosure and do not necessarily constitute prior art.

Automation of semiconductor processes and optimization of data communication are emerging as important factors in improving productivity. Accordingly, in order to standardize data communication in semiconductor processes, the Equipment Automation Division of Semiconductor Equipment and Materials International (SEMI) is establishing a SEMI Equipment Communications Standard (SECS) protocol, which is a standard protocol for data communication for an interface between semiconductor equipment and external computers. Through this, SEMI is requiring semiconductor equipment manufacturers to implement this as an option, thereby ensuring that semiconductor manufacturing equipment follows the SECS protocol standard in the interface portion.

In addition, as semiconductor processes continue to develop and fine processes increase, there is a growing demand to acquire and analyze more sensors and high-resolution process data from equipment. As a result, SEMI established a protocol for processing analysis data exclusively through a channel separate from the SECS protocol, and defined this as the Equipment Data Acquisition standard (hereinafter referred to as the EDA standard).

The EDA standard provides a document describing the specification and a complimentary file containing XML schema and web service description language (WSDL) required for SOAP message transmission.

The EDA standard consists of four parts as follows, thereby defining a series of services for equipment data acquisition and allowing the data from the equipment to be transmitted to an analysis system.

### E120: Common Equipment Model

Provide guidance on the equipment structure required to create equipment metadata and definitions of the attribute values provided by each node of the equipment (equipment node).

### E125: Equipment Self Description

The equipment manufacturer provides parameters, event information (state machines, simple events), exceptions, and SEMI objects required to collect data from the equipment node. When metadata is revised, the equipment notifies a client of a metadata change.

### E132: Authentication & Authorization

Through interface discovery, the client (system supervisor) receives a service URL of a server (equipment). Create and manage an access control list (ACL) through a security management unit (Security Admin). The created ACL is managed using a session management service. When establishing a session, the client specifies a consumer's URL (HTTP end point) to the equipment, and the equipment provides a client service to the URL.

### E134: Data Collection Management

Create a data collection plan (DCP) using metadata received from the equipment. The data collection plan is set to an event, an exception, and a trace, and data is transmitted when the plan is activated.

### DISCLOSURE OF INVENTION

### Technical Problem

An aspect of the present disclosure is to provide an architecture that can manage an entire process of acquiring data from semiconductor equipment according to the SEMI standards and a support device therefor.

An aspect of the present disclosure is to provide a method for guaranteeing that data is acquired in sequence during a process of acquiring data from semiconductor equipment according to the SEMI standards and a device supporting the same.

An aspect of the present disclosure is to provide a device for supporting a process of acquiring data from semiconductor equipment according to the SEMI standards and a session operation method for equipment data acquisition.

An aspect of the present disclosure is to provide a method for switching a process to be activated among processes executed in an equipment data acquisition device in a process of acquiring data from semiconductor equipment according to the SEMI standards and a device supporting the same.

### Technical Solution

In order to achieve the foregoing objectives, an equipment data acquisition support device according to one embodiment of the present disclosure may include a plurality of interfaces including a first interface for receiving a command from a user terminal and responding to the received command, and a second interface for transmitting a command to semiconductor equipment and receiving a response according to the command according to the equipment data acquisition (EDA) standards, a metadata management unit that provides access to metadata of the semiconductor equipment to the user terminal through the first interface, a security management unit that provides access to an access control list (ACL) including access privilege information for the semiconductor equipment to the user terminal through the first interface, a session management unit that provides a session connection based on the access control list to the user terminal through the first interface; and a data collection plan management unit that provides access to a data collection plan (DCP) of the semiconductor equipment defined based on the metadata to the user terminal through the first interface.

The security management unit grants a privilege while at the same time creating an ACL for a user to access the equipment, and the session management unit is responsible for all session information required for accessing the equipment through the created ACL and for subsequent metadata loading and data collection plan management.

The session management unit registers semiconductor equipment in an equipment list based on an access address for the semiconductor equipment received from the user terminal through the first interface, accesses the equipment using the ACL created through the security management unit, and then examines session information of all information exchanged through the accessed session.

Additionally, an access address of a consumer server to be provided with an EDA client service may be mapped to the semiconductor equipment. The connection address of the consumer server may be a different connection address from that of the equipment data acquisition support device.

The metadata management unit receives metadata from the semiconductor equipment through the second interface, thereby providing data configuration information of the equipment so as to create a data collection plan.

The data collection plan management unit may synchronize the access address of the consumer server mapped to the semiconductor equipment with an active state of the data collection plan defined for the semiconductor equipment through the second interface.

The active state of the data collection plan may be maintained independently of a connection state between the semiconductor equipment and the equipment data acquisition support device.

In addition, an equipment data acquisition method according to one embodiment of the present disclosure may include adding, by an equipment data acquisition support device, an access control list including access privilege information for semiconductor equipment, connecting, by the equipment data acquisition support device, a session for the semiconductor equipment based on an item corresponding to a user of a user terminal among items included in the access control list, loading, by the equipment data acquisition support device, metadata of the semiconductor equipment connected to the session, creating, by the equipment data acquisition support device, a data collection plan of the semiconductor equipment based on the loaded metadata, and activating, by the equipment data acquisition support device, the created data collection plan.

The method may further include, prior to adding the access control list, registering, by the equipment data acquisition support device, other users to access the equipment data acquisition support device based on information on other users received from the user terminal, registering, by the equipment data acquisition support device, semiconductor equipment to be managed by the equipment data acquisition support device based on a semiconductor equipment access address that has received from the user terminal, and registering, by the equipment data acquisition support device, consumer servers to collect data from the semiconductor equipment based on a consumer server access address that has received from the user terminal.

The loading of the metadata may include receiving, by the equipment data acquisition support device, a list of existing data collection plans defined in semiconductor equipment connected to the session, wherein the creating of the data collection plan includes creating, by the equipment data acquisition support device, a new data collection plan based on the metadata and the existing data collection plans, the method further including, subsequent to creating the data collection plan, receiving, by the equipment data acquisition support device, a real-time parameter value corresponding to the new data collection plan.

The method may further include, subsequent to activating the data collection plan, redefining, by the equipment data acquisition support device, the data collection plan of the semiconductor equipment into the new data collection plan, and synchronizing, by the equipment data acquisition support device, an active state of the new data collection plan defined in the semiconductor equipment.

In addition, an equipment data acquisition support device according to one embodiment of the present disclosure may include a memory in which at least one program is recorded, and a central processing unit (CPU) that executes the program, wherein the program includes instructions to perform the operations of adding an access control list including access privilege information for semiconductor equipment, connecting a session to the semiconductor equipment based on an item corresponding to a user of the user terminal among items included in the access control list, loading metadata of the semiconductor equipment connected to the session, creating a data collection plan of the semiconductor equipment based on the loaded metadata, and activating the created data collection plan.

### Advantageous Effects

According to the present disclosure, an architecture that can manage an entire process of acquiring data from semiconductor equipment according to the SEMI standards and a support device therefor may be provided.

According to the present disclosure, a method for guaranteeing that data is acquired in sequence during a process of acquiring data from semiconductor equipment according to the SEMI standards and a device supporting the same may be provided.

According to the present disclosure, a device for supporting a process of acquiring data from semiconductor equipment according to the SEMI standards and a session operation method for equipment data acquisition may be provided.

According to the present disclosure, a method for switching a process to be activated among processes executed in an equipment data acquisition device in a process of acquiring data from semiconductor equipment according to the SEMI standards and a device supporting the same may be provided.

### BRIEF DESCRIPTION OF THE DRAWINGS

FIG. 1 is a diagram showing a network relationship between an equipment data acquisition support device and other principals transmitting and receiving data according to one embodiment of the present disclosure.

FIG. 2 is a reference diagram showing a SEMI standard-based equipment data acquisition architecture according to one embodiment of the present disclosure.

FIG. 3 is a block diagram showing a configuration of an equipment data acquisition support device according to one embodiment of the present disclosure.

FIG. 4 is an operation flowchart showing an equipment data acquisition support method according to one embodiment of the present disclosure.

FIG. 5 is an operation flowchart showing an equipment data acquisition support method according to another one embodiment of the present disclosure.

FIG. 6 is an operation flowchart showing an equipment data acquisition support method according to still another one embodiment of the present disclosure.

FIG. 7 is an operation flowchart showing an equipment data acquisition support method according to yet still another one embodiment of the present disclosure.

FIG. 8 is a reference diagram showing a session connection structure for SEMI standard-based equipment data acquisition according to one embodiment of the present disclosure.

FIG. 9 is an operation flowchart showing a session operation method for equipment data acquisition according to one embodiment of the present disclosure.

FIG. 10 is an operation flowchart showing a session operation method for equipment data acquisition according to another one embodiment of the present disclosure.

FIG. 11 is a block diagram showing a configuration of an equipment data acquisition device according to one embodiment of the present disclosure.

FIG. 12 is an operation flowchart showing a method of guaranteeing an acquisition sequence of equipment data according to one embodiment of the present disclosure.

FIG. 13 is an operation flowchart showing a method of guaranteeing an acquisition sequence of equipment data according to another one embodiment of the present disclosure.

FIG. 14 is a reference diagram showing a structure of processes executed in an equipment data acquisition device according to one embodiment of the present disclosure.

FIG. 15 is an operation flowchart showing a process switching method in an equipment data acquisition device according to one embodiment of the present disclosure.

FIG. 16 6 is an operation flowchart showing a process switching method in an equipment data acquisition device according to another one embodiment of the present disclosure.

FIG. 17 is an operation flowchart showing a process switching method in an equipment data acquisition device according to still another one embodiment of the present disclosure.

FIG. 18 is a diagram showing an computer system according to one embodiment of the present disclosure.

### BEST MODE FOR CARRYING OUT THE INVENTION

Advantages and features of the present disclosure, and methods of accomplishing the same will be clearly understood with reference to the following embodiments described below in detail in conjunction with the accompanying drawings. However, the present disclosure is not limited to those embodiments disclosed below but may be implemented in various different forms. It should be noted that the present embodiments are merely provided to make a full disclosure of the invention and also to allow those skilled in the art to know the full range of the invention, and therefore, the present disclosure is to be defined only by the scope of the appended claims. Like reference numerals refer to like elements throughout the specification.

Although the terms “first,” “second,” and the like are used to describe various elements, the elements are not limited to those terms. Those terms may be used only to distinguish one element from another element. Therefore, a first element mentioned below may also be a second element within the technical concept of the present disclosure.

It should be noted that the terms used herein are merely used to describe the embodiments, but not to limit the present disclosure. In this specification, unless clearly used otherwise, expressions in a singular form include a plural form. The terms “comprises” or “comprising” as used in the specification imply that the presence or addition of one or more other elements or steps is not excluded.

Unless otherwise defined, all terms used in this specification may be interpreted with meanings that can be commonly understood by those skilled in the art to which the present disclosure pertains. Additionally, terms defined in commonly used dictionaries are not interpreted ideally or excessively unless clearly specifically defined.

Hereinafter, preferred embodiments of the present disclosure will be described in detail with reference to the accompanying drawings.

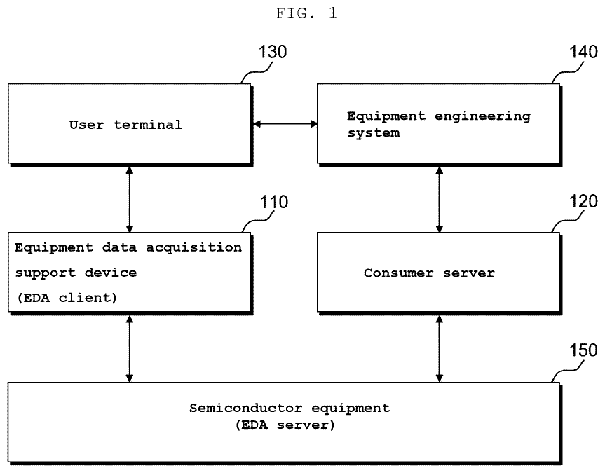

FIG. 1 is a diagram showing a network relationship between an equipment data acquisition support device 110 and other principals that transmit and receive data according to one embodiment of the present disclosure.

Referring to FIG. 1, the equipment data acquisition support device 110 according to one embodiment of the present disclosure may transmit and receive data to and from a user terminal 130 through a first interface, and transmit and receive data to and from semiconductor equipment 150 through a second interface.

The first interface may be an interface for the equipment data acquisition support device 110 to receive a command from the user terminal 130 and respond to the received command when the equipment data acquisition support device 110 is a server and the user terminal 130 is a client.

The second interface may be an interface for the equipment data acquisition support device 110 to transmit a command to the semiconductor equipment 150 and receive a response according to the command when the semiconductor equipment 150 is an EDA server according to the equipment data acquisition (EDA) standard, and the equipment data acquisition support device 110 is an EDA client.

The equipment data acquisition support device 110 may perform the role of an integrated host application server (HAS) to provide an equipment data acquisition service to the user terminal 130.

In the EDA standard, an EDA client is defined as being able to perform the functions of a host application server and a consumer server together, wherein the equipment data acquisition support device 110 of the present disclosure may be viewed as a device that mainly performs the role of a host application server, excluding the function performed by the consumer server among the functions performed by the EDA client.

The user terminal 130 may perform control related to data acquisition of the semiconductor equipment 150 via the equipment data acquisition support device 110, and may acquire data from the semiconductor equipment 150 through an equipment engineering system (EES) 140.

The semiconductor equipment 150 may receive a control command related to data acquisition from the user terminal 130 via the equipment data acquisition support device 110, and transmit data to the equipment data acquisition device 120 in response to the received command.

In the EDA standard, an EDA client is defined as being able to perform the functions of a host application server and a consumer server together, wherein the equipment data acquisition device 120 of the present disclosure may be viewed as a device that mainly performs the function of the consumer server among the functions performed by the EDA client.

For example, the equipment data acquisition device 120 may perform the function of a consumer server that acquires data from the semiconductor equipment 150, processes the data, and provides it to the equipment engineering system 140.

As an optional embodiment, the equipment data acquisition device 120 may be a server physically separated from the equipment data acquisition support device 110.

Through this, a session between the semiconductor equipment 150 and the equipment data acquisition device 120 may be maintained in an active state independently of a connection state between the equipment data acquisition support device 110 and the semiconductor equipment 150, and therefore there is an advantageous effect in which the equipment data acquisition device 120 can continuously acquire data from the semiconductor equipment 150 without intervention of the equipment data acquisition support device 110.

Here, the user terminal 130 refers to a communication terminal that can use a terminal application in a wired or wireless communication environment. Here, the communication terminal may be a user's personal computer, a user's portable terminal, or an internet of things based terminal.

To be more specific, the communication terminal may include any form of a communication terminal computer (e. g., desktop, laptop, tablet, etc.), a media computing platform (e.g., cable, satellite set-top box, digital video recorder), a handheld computing device (e.g., PDA, email client, etc.), a mobile phone, or any form of other types of computing or communication platforms, but the present disclosure is not limited thereto.

The equipment data acquisition support device 110 may be connected to the user terminal 130 and the semiconductor equipment 150 through a communication network.

The communication network refers to a connection path that allows data to be transmitted and received between the foregoing principals. For instance, the communication network may include wired networks such as local area networks (LANs), wide area networks (WANs), metropolitan area networks (MANS), and integrated service digital networks (ISDNs), or wireless networks such as wireless LANS, CDMAS, Bluetooths, and satellite communications, but the scope of the communication network applicable to the present disclosure is not limited thereto.

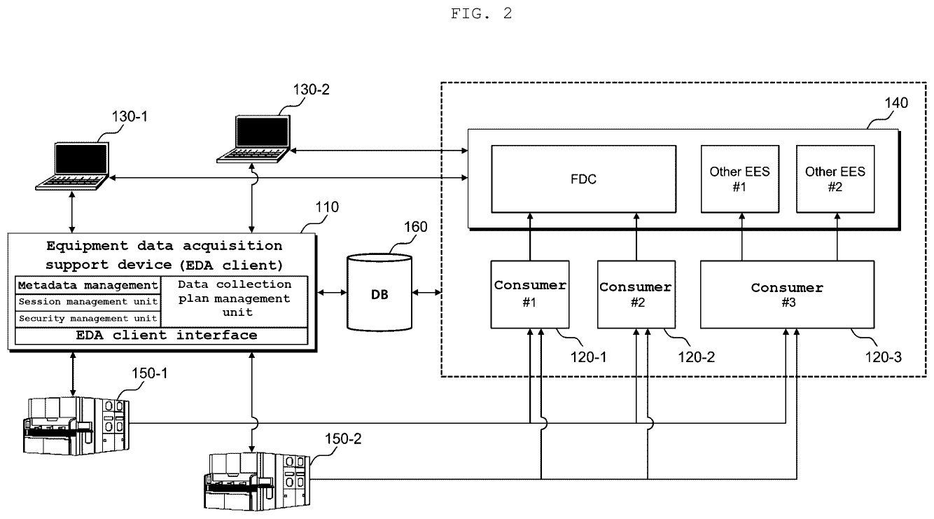

FIG. 2 is a reference diagram showing a SEMI standard-based equipment data acquisition architecture according to one embodiment of the present disclosure.

Referring to FIG. 2, the SEMI standard-based equipment data acquisition include an equipment data acquisition support device 110, equipment data acquisition devices 120-1, 120-2, 120-3, user terminals 130-1, 130-2, an equipment engineering system 140, semiconductor equipment 150-1, 150-2, and a database 160.

The equipment data acquisition support device 110 may be connected to the user terminals 130-1, 130-2 in a one-to-many relationship through the first interface to transmit and receive data.

The equipment data acquisition support device 110 may be connected to the semiconductor equipment 150-1, 150-2 in a one-to-many relationship through the second interface to transmit and receive data.

The semiconductor equipment 150-1, 150-2 and the equipment data acquisition devices 120-1, 120-2, 120-3 may be connected in a many-to-many relationship, and the semiconductor equipment 150-1, 150-2 may transmit data to the equipment data acquisition devices 120-1, 120-2, 120-3 in a push manner, and the equipment data acquisition devices 120-1, 120-2, 120-3 may transmit and receive data in a call-back manner to the semiconductor equipment 150-1, 150-2.

Here, the equipment data acquisition devices 120-1, 120-2, 120-3 may perform the role of end points of sessions established for the semiconductor equipment 150-1, 150-2.

As an optional embodiment, the equipment data acquisition devices 120-1, 120-2, 120-3 may store data received from the semiconductor equipment 150-1, 150-2 in a queue-structured storage to guarantee a sequence of the received data.

As another optional embodiment, in each of the equipment data acquisition devices 120-1, 120-2, 120-3, a plurality of applications may be driven, one of the applications may perform the role of a consumer, and when a failure occurs in the application performing the role of a consumer, another application that is being driven may take over the role of the consumer so as to overcome the failure of the consumer server. In this case, since access addresses of consumer servers mapped to semiconductor equipment are maintained as they are, there is an advantageous effect in that a failure of the consumer server may be overcome without intervention of the equipment data acquisition support device 110.

As still another optional embodiment, the semiconductor equipment 150-1, 150-2 and the equipment data acquisition devices 120-1, 120-2, 120-3 may be connected in a many-to-many relationship, and thus, when a failure occurs in one of the equipment data acquisition devices (e.g., 120-1), a connection relationship conversion may be performed so as to allow the semiconductor equipment connected to the equipment data acquisition device 120-1 to be connected to other equipment data acquisition devices. In this case, the access addresses of consumer servers mapped to the semiconductor equipment may be newly mapped by the equipment data acquisition support device 110.

The equipment data acquisition devices 120-1, 120-2, 120-3 may receive data from the semiconductor equipment 150-1, 150-2, convert the data, and transmit it to the equipment engineering system 140.

In the semiconductor equipment 150-1, 150-2, messages in an EDA standard format (e.g., SOAP or XML) may be acquired as data, and the equipment data acquisition devices 120-1, 120-2, 120-3 may convert the data into a message in a format required by a user or equipment engineering system and provide it to the equipment engineering system 140.

The equipment engineering system 140 may include various equipment engineering systems including fault detection & classification (FDC) and may provide converted data to the user terminals 130-1, 130-2.

The database 160 may be a storage in which information including session information, metadata information, and data collection plan information and various types of information on semiconductor equipment are stored, so as to allow information required by the equipment data acquisition support device 110, the equipment data acquisition devices 120-1, 120-2, 120-3, and the equipment engineering system 140 to be integrated and managed.

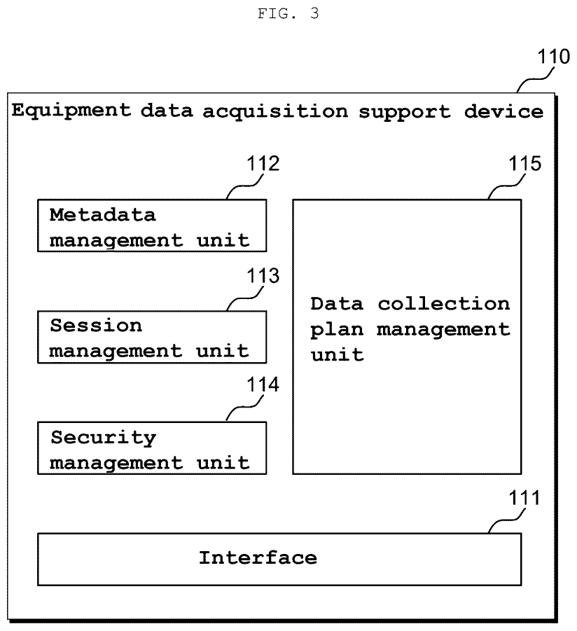

FIG. 3 is a block diagram showing a configuration of the equipment data acquisition support device 110 according to one embodiment of the present disclosure.

Referring to FIG. 3, the equipment data acquisition support device 110 according to one embodiment of the present disclosure may include a plurality of interfaces 111, a metadata management unit 112, a session management unit 113, a security management unit 114, and a data collection plan management unit 115.

The plurality of interfaces 111 may include a first interface for receiving a command from a user terminal and responding to the received command, and a second interface for transmitting a command to semiconductor equipment and receiving a response according to the command according to the equipment data acquisition (EDA) standard.

The metadata management unit 112 may provide access to metadata of semiconductor equipment to a user terminal through the first interface.

The metadata management unit 112 may receive metadata from the semiconductor equipment through the second interface when a session is connected and store it in a database, or provide it to the user terminal through the first interface.

Here, the metadata may be converted and stored in tree or table form.

As an optional embodiment, when a default location for retrieving metadata when a session is connected is set to a database rather than semiconductor equipment, the metadata management unit 112 may retrieve metadata from the database and provide it to the user terminal through the first interface.

The session management unit 113 may register semiconductor equipment in an equipment list based on an access address for the semiconductor equipment received from the user terminal through the first interface.

Here, the access address may be a uniform resource locator (URL).

The session management unit 113 may map an access address of a consumer server to the semiconductor equipment registered in the equipment list based on the access address for the consumer server received from the user terminal through the first interface.

Here, the consumer server is a server physically separated from the equipment data acquisition support device 110, and the access address of the consumer server may be a different address from that of the equipment data acquisition support device 110.

The session management unit 113 may provide a session connection based on an access control list (ACL) including access privilege information for semiconductor equipment to the user terminal through the first interface.

Upon receiving a session connection command from the user terminal through the first interface, the session management unit 113 may connect the session based on an access control list item corresponding to the user of the user terminal in response thereto.

The session may be divided into a user terminal session connected between the user terminal and the equipment data acquisition support device 110, an EDA session connected between the equipment data acquisition support device 110, the semiconductor equipment and the equipment data acquisition device 120, and an EES session connected between an analysis system server and an equipment engineering system.

The EDA session may be connected using the access control list corresponding to semiconductor equipment users and end point information according to the SEMI standards.

The session management unit 113 may manage a session active state for each semiconductor equipment and each data collection plan.

The session management unit 113 may receive session information from the semiconductor equipment, and verify the session information received from the semiconductor equipment using at least one of a session, metadata, and a data collection plan managed by the equipment data acquisition support device.

The session management unit 113 may synchronize the parameters of the semiconductor equipment through the second interface so as to allow the access address of the consumer server mapped to the semiconductor equipment and the active state of the data collection plan defined for the semiconductor equipment to be applied to the semiconductor equipment.

The security management unit 114 may provide access to the access control list to the user terminal through the first interface.

The security management unit 114 may receive an ACL acquisition command (Get ACL) from the user terminal through the first interface, and receive privilege items from the semiconductor equipment in response thereto.

Next, the security management unit 114 may receive an add role command (Add Role) from the user terminal through the first interface, and map role information to at least one of the privilege items in response thereto.

Next, the security management unit 114 may receive an add principal command (Add Principal) from the user terminal through the first interface, and map principal information to at least one of the privilege items in response thereto.

An access control list including the foregoing mapping result is provided, and the access control list may include items in which role information or principal information is mapped to at least one of the privilege items for semiconductor equipment.

The security management unit 114 may activate or deactivate session connections for specific users.

For example, the security management unit 114 may provide a list of activated sessions to the user terminal through the first interface, and deactivate the session in response to a deactivation command for a specific session received from the user terminal.

The data collection plan management unit 115 may provide access to a data collection plan (DCP) of semiconductor equipment defined based on metadata to the user terminal through the first interface.

The data collection plan management unit 115 may receive a list of data collection plans defined in the semiconductor equipment through the second interface when a session is connected and provide it to the user terminal through the first interface.

The data collection plan management unit 115 may receive a data collection plan refresh command from the user terminal through the first interface, receive a list of data collection plans defined in the semiconductor equipment through the second interface in response thereto, and provide the list to the user terminal through the first interface.

The data collection plan management unit 115 may receive a data collection plan creation (Define DCP) command including a type of data collection plan to be created and setting values of the data collection plan from the user terminal through the first interface, and create a data collection plan of the type specified by the user in response thereto.

Here, the type of data collection plan may include at least one of trace, an event, an exception, and a combination.

When the type of data collection plan is a trace, data may be acquired or stopped from the semiconductor equipment depending on whether there is an event or alarm specified in a start or stop trigger.

The data collection plan management unit 115 may receive an activation or deactivation command for a specific data collection plan from the user terminal through the first interface, and activate or deactivate a data collection plan specified by the user in response thereto.

The data collection plan management unit 115 may receive a delete command of a specific data collection plan from the user terminal through the first interface, and delete a data collection plan specified by the user in response thereto.

The data collection plan management unit 115 may define a data collection plan by utilizing metadata stored in a database to prevent overlapping metadata from being acquired from the same semiconductor equipment for each user and each session.

The data collection plan management unit 115 may perform an overlap check on a data collection plan to prevent an overlapping data collection plan from being created for the same semiconductor equipment.

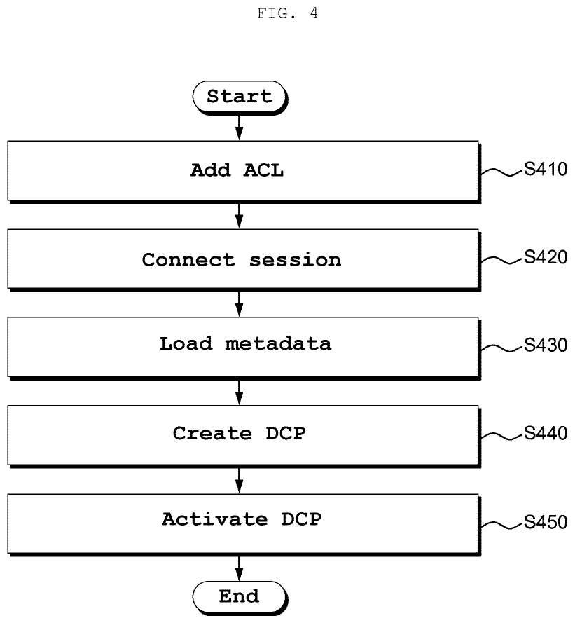

FIG. 4 is an operation flowchart showing an equipment data acquisition support method according to one embodiment of the present disclosure.

Referring to FIG. 4, in a method for supporting equipment data acquisition according to one embodiment of the present disclosure, first, an equipment data acquisition support device may add an access control list (ACL) including access privilege information on semiconductor equipment (S410).

Here, the equipment data acquisition support device may receive a privilege list from the semiconductor equipment, and create an access control list including items in which at least one of privileges included in the privilege list is mapped to a role or principal.

Next, the equipment data acquisition support device may connect a session for the semiconductor equipment based on an item corresponding to a user of a user terminal among the items included in the access control list (S420).

Here, the equipment data acquisition support device may disable session connections of other users upon request from the user.

For example, the equipment data acquisition support device may provide a list of activated sessions to the user terminal, and deactivate the session in response to a deactivation command for a specific session received from the user terminal.

Next, the equipment data acquisition support device may load metadata from the semiconductor equipment connected to the session (S430).

Here, the equipment data acquisition support device may store the metadata of the semiconductor equipment in the database or provide it to the user terminal.

Next, the equipment data acquisition support device may create a data collection plan (DCP) of the semiconductor equipment based on the metadata (S440).

Here, the equipment data acquisition support device may perform an overlap check on whether the new data collection plan overlaps an existing data collection plan.

Next, the equipment data acquisition support device may activate the created data collection plan (S450).

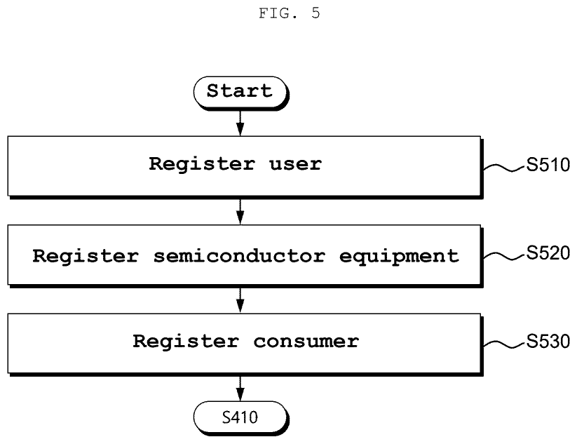

FIG. 5 is an operation flowchart showing an equipment data acquisition support method according to another one embodiment of the present disclosure.

In particular, FIG. 5 is an operation flowchart showing a process of registering a user of an equipment data acquisition support device, a semiconductor equipment as an EDA server, and a consumer server to be provided with an EDA client service.

Referring to FIG. 5, an equipment data acquisition support method according to another one embodiment of the present disclosure may register other users to access the equipment data acquisition support device based on information on the other users received from the user terminal (S510).

Next, the equipment data acquisition support device may register semiconductor equipment to be managed by the equipment data acquisition support device based on an access address for the semiconductor equipment received from the user terminal (S520).

Here, when there is an interface search command from the user terminal, the equipment data acquisition support device may access the semiconductor equipment using the access address of the semiconductor equipment, and receive an equipment name and an EDA web service address (web service URL) from the semiconductor equipment and map them to the semiconductor equipment.

Next, the equipment data acquisition support device may register consumer servers to acquire data from semiconductor equipment based on an access address for the consumer server received from the user terminal (S530).

Here, the equipment data acquisition support device may map an access address of a consumer server to be provided with an EDA client service to semiconductor equipment.

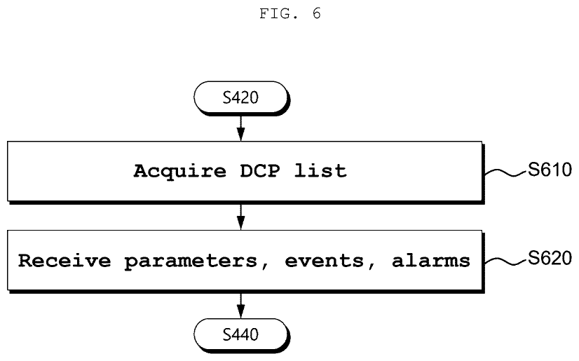

FIG. 6 is an operation flowchart showing an equipment data acquisition support method according to yet still another one embodiment of the present disclosure.

In particular, FIG. 6 is a flowchart showing a process of creating and managing a data collection plan in an equipment data acquisition support device.

Referring to FIG. 6, an equipment data acquisition support method according to yet still another one embodiment of the present disclosure may receive a data collection plan list defined in the semiconductor equipment together with the equipment data acquisition support device when metadata from semiconductor equipment to which a session is connected (S610).

Next, the equipment data acquisition support device may receive real-time parameter values, events, and alarms corresponding to the new data collection plan (S620).

The equipment data acquisition support device may provide real-time parameter values corresponding to the new data collection plan to the user terminal, thereby providing a real-time data collection test according to the new data collection plan.

Through this, the equipment data acquisition support device has an advantageous effect of being able to create a new data collection plan that does not overlap the existing data collection plan list predefined in the semiconductor equipment, while also being able to test in real time whether data is acquired well according to the new data collection plan.

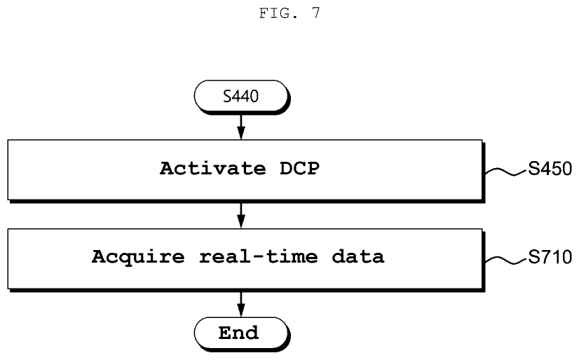

FIG. 7 is an operation flowchart showing an equipment data acquisition support method according to yet still another one embodiment of the present disclosure.

In particular, FIG. 7 is an operation flowchart showing a process of applying a data collection plan created in the equipment data acquisition support device to semiconductor equipment and acquiring data.

Referring to FIG. 7, an equipment data acquisition support method according to another one embodiment of the present disclosure may activate a new data collection plan created by the equipment data acquisition support device (S450).

Here, the new data collection plan is set so as to allow a state value in the equipment data acquisition support device indicates an active state, and the semiconductor equipment may be prior to being synchronized with the new data collection plan or the active state of the new data collection plan.

Next, the equipment data acquisition support device may redefine the data collection plan of the semiconductor equipment as a new data collection plan, and synchronize the active state of the new data collection plan to allow real-time data to be acquired from the semiconductor equipment to the consumer server (S710).

As an optional embodiment, the equipment data acquisition support device may display real-time data acquired by the consumer server on a user interface provided through the user terminal, with different visual effects applied thereto according to the type of data collection plan corresponding to the real-time data.

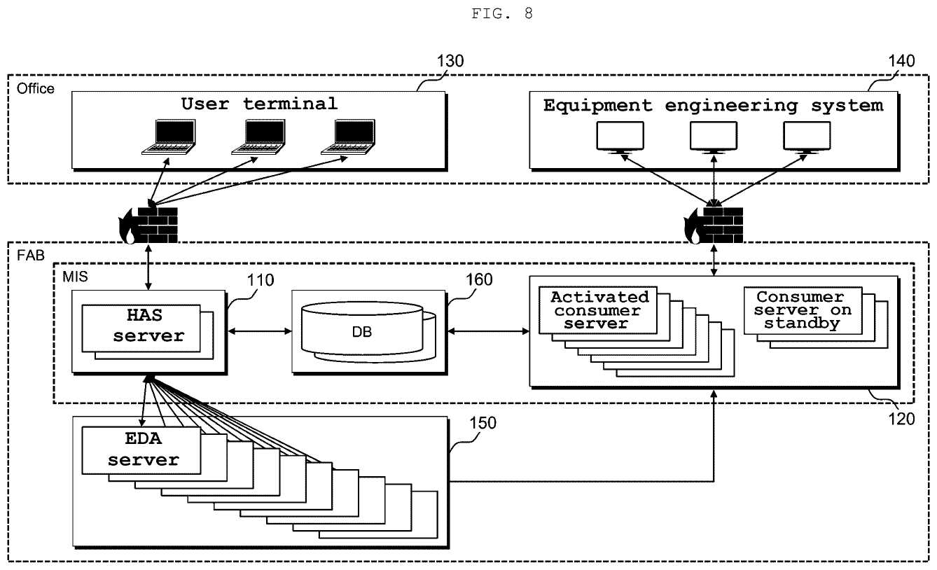

FIG. 8 is a reference diagram showing a session connection structure for SEMI standard-based equipment data acquisition according to one embodiment of the present disclosure.

Referring to FIG. 8, principals for SEMI standard-based equipment data acquisition according to one embodiment may include an equipment data acquisition support device 110, an equipment data acquisition device 120, semiconductor equipment 150, and a database 160 located on a semiconductor factory (FAB) side, and a user terminal 130 and an equipment engineering system 140 located on an office side.

The semiconductor factory (FAB) and the office may be different location areas that are geographically distant.

The equipment data acquisition support device 110 may receive control commands for data acquisition control from a plurality of user terminals 130 that wish to control data acquisition from semiconductor equipment 150, and provide control result information to the user terminals 130 in response thereto.

The equipment data acquisition support device 110 may transmit a second control command corresponding to a first control command received from the plurality of user terminals 130 to the semiconductor equipment 150, and provide first control result information corresponding to second control result information received from the semiconductor equipment 150 to the user terminals 130.

Here, a connection between the equipment data acquisition support device 110 and the user terminal 130 may be made through a user terminal session, and a connection between the equipment data acquisition support device 110 and the semiconductor equipment 150 may be made through an EDA session.

The equipment data acquisition support device 110 may set the equipment data acquisition device 120 to collect data from the semiconductor equipment as an endpoint to establish an EDA session with the semiconductor equipment 150.

That is, since all user terminals 130 are not directly accessed to the semiconductor equipment 150 that the user wishes to control, but are accessed to the equipment data acquisition support device 110 that performs the role of a HAS server, network traffic between the factory (FAB) side and the user terminals 130 may only occur between the equipment data acquisition support device 110 and the user terminals 130.

In addition, since the equipment engineering systems 140 do not acquire data directly from the semiconductor equipment 150, but rather acquire data from the equipment data acquisition device 120 or an analysis system server at a rear of the equipment data acquisition device 120, network traffic between the factory (FAB) side and the equipment engineering systems 140 may occur only between the equipment data acquisition device 120 and the equipment engineering systems 140, or occur only between the analysis system server and the equipment engineering systems 140.

Accordingly, network traffic between the factory (FAB) side and the office side may be managed through a first firewall setting to allow the user terminals 130 to access the equipment data acquisition support device 110 and a second firewall setting to allow the equipment engineering systems 140 to access the equipment data acquisition device 120 or the analysis system server.

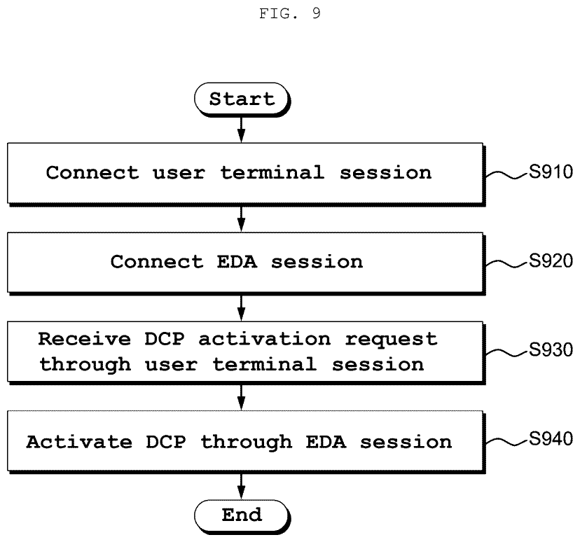

FIG. 9 is an operation flowchart showing a session operation method for equipment data acquisition according to one embodiment of the present disclosure.

Referring to FIG. 9, a session operation method for equipment data acquisition according to one embodiment of the present disclosure may first allow an equipment data acquisition support device to connect a user terminal session to a user terminal that wishes to control data acquisition from n semiconductor equipment (S910).

Here, the user terminal session may be a session for the equipment data acquisition support device to receive a first control command corresponding to the control of data acquisition from the user terminal and provide first control result information as a response to the first control command to the user terminal.

Although not shown in FIG. 9, the equipment data acquisition support device may connect a user terminal session, and then connect an EDA session to semiconductor equipment, or provide information on an already connected EDA session to the user terminal through the user terminal session.

Here, the EDA session may be a session for the equipment data acquisition support device to transmit a second control command to the semiconductor equipment and receive second control result information as a response to the second control command from the semiconductor equipment.

The equipment data acquisition support device may load information on EDA sessions connected to semiconductor equipment from a database prior to connecting an EDA session, and provide information on the EDA sessions to the user terminal.

The equipment data acquisition support device may connect an EDA session based on an access control list (ACL) corresponding to equipment engineering system (EES) designation information received from the user terminal, and the equipment data acquisition device may post-process data acquired from semiconductor equipment and transmit it to an equipment engineering system.

When the EDA session is connected, the equipment data acquisition device that acquires data from the semiconductor equipment may be set as an end point.

The equipment data acquisition support device may connect an EDA session so as not to allow an access control list and an end point to overlap.

The equipment data acquisition support device may connect an EDA session, then load metadata of the semiconductor equipment, and provide the metadata to the user terminal.

The equipment data acquisition support device may determine whether metadata is present in a database, and load, when the metadata is not present in the database, metadata from semiconductor equipment, and then store the loaded metadata in the database, and load, when the metadata is present in the database, the metadata from the database.

The equipment data acquisition support device may connect an EDA session, then load state information of a data collection plan created for the semiconductor equipment from the database, and provide the state information of the data collection plan to the user terminal.

The data collection plan or metadata may be provided to the data acquisition device when the database is refreshed or when the data acquisition device is initialized.

Next, the equipment data acquisition support device may receive an activation request for a a data collection plan corresponding to the semiconductor equipment through the user terminal session (S920).

Next, the equipment data acquisition support device may activate the data collection plan through the EDA session (S930).

The equipment data acquisition support equipment may activate a data collection plan through an EDA session corresponding to an end point included in an activation request of the data acquisition plan.

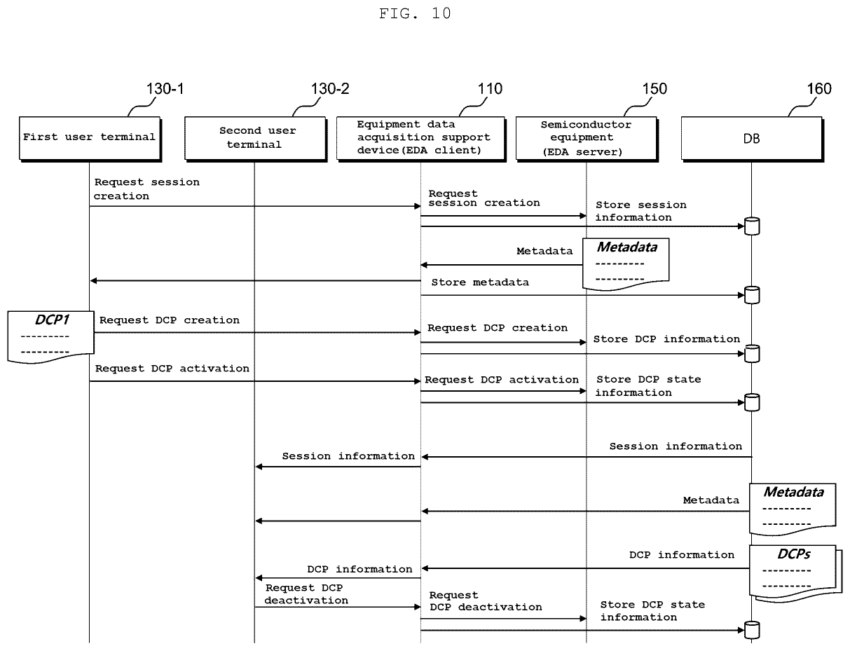

FIG. 10 is an operation flowchart showing a session operation method for equipment data acquisition according to another one embodiment of the present disclosure.

Referring to FIG. 10, in a session operation method for equipment data acquisition according to another one embodiment of the present disclosure, first, when a first user terminal 130-1 requests an EDA session connection from the equipment data acquisition support device 110, the equipment data acquisition support device 110 may connect an EDA session to the first semiconductor equipment 150-1, and store EDA session information in the database 160.

In an initial state, since metadata of the first semiconductor equipment 150-1 is not stored in the equipment data acquisition support device 110 or the database 160, the equipment data acquisition support device 110 may directly receive the metadata from the first semiconductor equipment 150-1, provide the metadata to the first user terminal 130-1, and store it in the database 160.

Next, when the first user terminal 130-1 requests the equipment data acquisition support device 110 to create a DCP, the equipment data acquisition support device 110 may request the creation of the DCP to the first semiconductor equipment 150-1 using the EDA session connected to the first semiconductor equipment 150-1, and store the requested DCP information in the database 160.

Next, when the first user terminal 130-1 requests the activation of a DCP from the equipment data acquisition support device 110, the equipment data acquisition support device 110 may request the activation of the DCP in the first semiconductor equipment 150-1 using the EDA session connected to the first semiconductor equipment 150-1, and store state information indicating that the DCP is active in the database 160.

In this way, when an EDA session is connected between the equipment data acquisition support device 110 and the first semiconductor equipment 150-1 according to a request received from the first user terminal 130-1, metadata is stored once, a DCP is created, and state information is created, related information may be provided so as to be utilized by the second user terminal 130-2 that connects later.

For example, when the second user terminal 130-2 is connected to the equipment data acquisition support device 110, the equipment data acquisition support device 110 may acquire session information, metadata, and DCP information stored in the database and provide them to the second user terminal 130-2, thereby allowing the user of the second user terminal 130-2 to confirm that an EDA session has been created for the first user terminal 130-1 and that a DCP has been created and is in an active state.

Next, when second user terminal 130-2 requests the deactivation of a DCP from the equipment data acquisition support device 110, the equipment data acquisition support device 110 may request the deactivation of the DCP in the first semiconductor equipment 150-1 using the EDA session connected to the first semiconductor equipment 150-1, and store state information indicating that the DCP is inactive in the database 160.

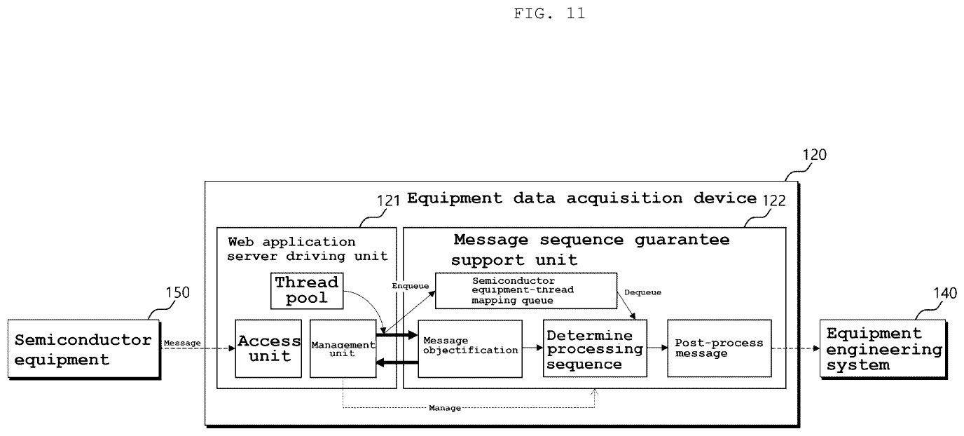

FIG. 11 is a block diagram showing a configuration of the equipment data acquisition device 120 according to one embodiment of the present disclosure.

Referring to FIG. 11, the equipment data acquisition device 120 according to one embodiment of the present disclosure may include a web application server driving unit 121 and a message sequence guarantee support unit 122.

The semiconductor equipment 150 may transmit data acquired in the form of a message to the equipment data acquisition device 120 according to the activated data collection plan.

The web application server driving unit 121 may allocate one thread to each message in a sequence in which the messages are accepted from the semiconductor equipment 150, and drive a web application server (WAP) to receive the messages through the thread.

Here, upon receiving a packet from the semiconductor equipment through an access unit, the web application server may determine whether a packet format corresponds to a HTTP protocol from a header of the packet, and allocate one of the threads registered in a thread pool to receive a payload of the packet.

A thread is allocated to perform an entire process from receiving, objectifying, and post-processing a single message, that is, one thread may be dedicated to handling one message.

The web application server may manage the message sequence guarantee support unit 122 through a management unit.

For example, in the case of JAVA, the management unit may be a servlet handler, and the message sequence guarantee support unit 122 may be a servlet managed by the servlet handler.

The thread may perform various steps, including logging, depending on an interceptor chain included in the servlet, and may call, upon having received a message, a function for determining a processing sequence and performing post-processing among various functions included in the interceptor chain.

As an optional embodiment, a CXF servlet may be used to perform the role of the message sequence guarantee support unit 122.

In this case, the CXF servlet may be executed in a state in which a one way processor interceptor in the interceptor chain is disabled, thereby preventing a new thread from being allocated to execute a function called in the interceptor chain.

Through this, when a function for determining a processing sequence and performing post-processing is called in the interceptor chain included in the CXF servlet, a function for determining a processing sequence and performing post-processing may be executed by a thread that has received the message without changing from the thread that has received the message to another thread.

Here, the message sequence guarantee support unit 122 may queue identification information of a thread in an allocation sequence of the thread in a queue created in response to the semiconductor equipment.

Here, the identification information may be in the form of an Internet Protocol (IP) address or a combination of an IP address and a port.

A thread may receive and objectify a message payload by queuing identification information into a semiconductor equipment-to-thread mapping queue.

The semiconductor equipment-thread mapping queue may be created one by one for each semiconductor equipment, wherein the semiconductor equipment and the semiconductor equipment-thread mapping queues have a one-to-one correspondence relationship.

Here, objectification may refer to changing a payload of a message transmitted by semiconductor equipment into an objectified data format (e.g., XML or JSON format) according to the EDA standard.

Here, the message sequence guarantee support unit 122 may determine a processing sequence of one message by using the identification information of one thread and a semiconductor equipment-thread mapping queue when the one thread has received the one message.

The message sequence guarantee support unit 122 may perform post-processing on messages in a sequence in which the message have been accepted.

Here, post-processing may refer to converting the format of a message into a format required by the equipment engineering system (EES).

Here, the message sequence guarantee support unit 122 may dequeue the identification information of a thread corresponding to a message whose processing sequence has arrived from the semiconductor equipment-thread mapping queue.

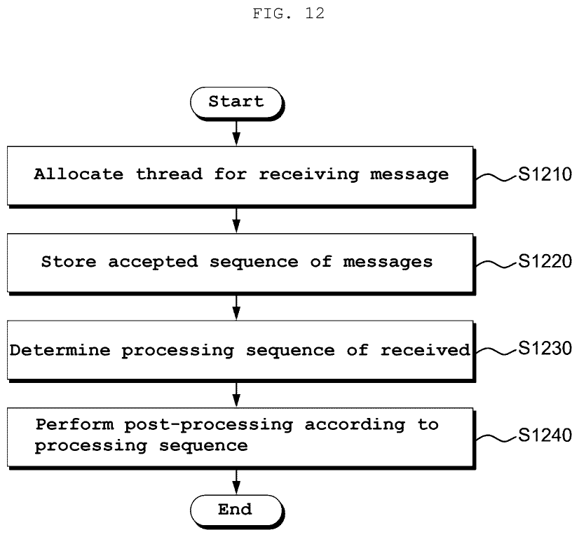

FIG. 12 is an operation flowchart showing a method of guaranteeing an acquisition sequence of equipment data according to one embodiment of the present disclosure.

Referring to FIG. 12, a method of guaranteeing an acquisition sequence of equipment data according to one embodiment of the present disclosure may first allow an equipment data acquisition device to allocate a first thread for receiving a first message from semiconductor equipment (S1210).

Here, the equipment data acquisition device may allocate one thread to each of the messages in a sequence in which a first packet of the message has received.

Next, the equipment data acquisition device may store an accepted sequence of the first message using first identification information of the first thread (S1220).

Here, the equipment data acquisition device may store the accepted sequence of the first message by queuing the first identification information in a semiconductor equipment-thread mapping queue created in response to the semiconductor equipment.

Next, the equipment data acquisition device may determine a processing sequence of a second message using second identification information of a second thread that has received the second message and an accepted sequence of the messages (S1230).

Here, the equipment data acquisition device may determine that the processing sequence of the second message has arrived when the second identification information corresponds to a foremost item of the semiconductor equipment-thread mapping queue.

More specifically, the equipment data acquisition device may call a function for determining a processing sequence and performing post-processing through a second thread that has received a second message, which is one of the messages, and compare second identification information of the second thread that has called the function with a foremost item of a semiconductor equipment-thread mapping queue, and determine that the processing sequence of the second message received by the second thread has arrived when the second identification information corresponds to the foremost item of the semiconductor equipment-thread mapping queue.

Here, the equipment data acquisition device may repeatedly compare the second identification information and the foremost item of the semiconductor equipment-thread mapping queue for a preset life cycle in the second thread.

When there is no match between the second identification information and the foremost item of the semiconductor equipment-thread mapping queue during the preset life cycle, the processing of the second message may be skipped.

Next, the equipment data acquisition device may perform post-processing on the second message in the processing sequence (S1240).

Here, the equipment data acquisition device may dequeue the foremost item of the semiconductor equipment-thread mapping queue.

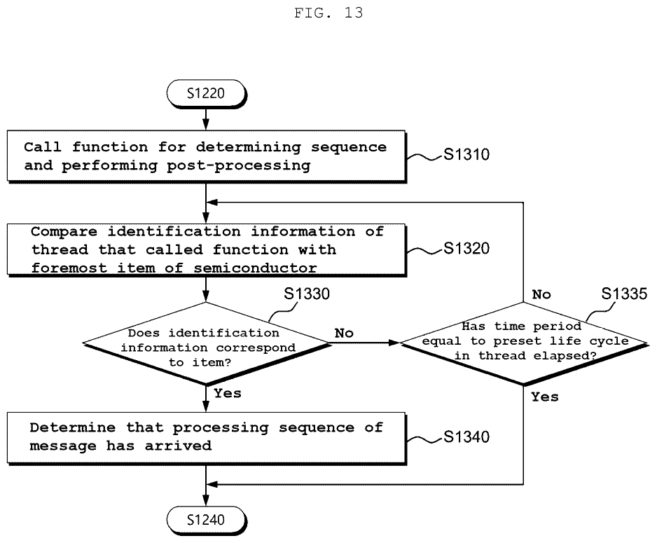

FIG. 13 is an operation flowchart showing a method of guaranteeing an acquisition sequence of equipment data according to another one embodiment of the present disclosure.

In particular, FIG. 13 is a flowchart showing a process of determining a processing sequence of messages received by a thread.

Referring to FIG. 13, a method of guaranteeing an acquisition sequence of equipment data according to another one embodiment of the present disclosure may first allow an equipment data acquisition device to call a function for determining a processing sequence and performing post-processing through a thread that has received one message (S1310).

Next, the equipment data acquisition device may compare identification information of the thread that called the function with a foremost item of the semiconductor equipment-thread mapping queue (S1320).

Here, the Equipment Data Acquisition Device May determine whether the identification information of the thread corresponds to the foremost item of the semiconductor equipment-thread mapping queue (S1330).

When the identification information of the thread corresponds to the foremost item of the semiconductor equipment-thread mapping queue as a result of the determination, the equipment data acquisition device may determine that the processing sequence of the message received by the thread has arrived (S1340).

When the identification information of the thread does not correspond to the foremost item of the semiconductor equipment-thread mapping queue as a result of the determination, the equipment data acquisition device may determine whether a time period equal to a preset life cycle in the thread has elapsed (S1335).

When it is determined that the time period equal to the preset life cycle in the thread has not elapsed, the equipment data acquisition device may repeatedly compare second identification information with the foremost item of the semiconductor equipment-thread mapping queue (S1320).

When the time period equal to the preset life cycle in the thread has elapsed as a result of the determination, the equipment data acquisition device may not determine that the processing sequence of the message has arrived, and the data acquisition device may process the message according to the processing sequence in a subsequent step (e. g., S1240), thereby allowing the processing of the message to be skipped.

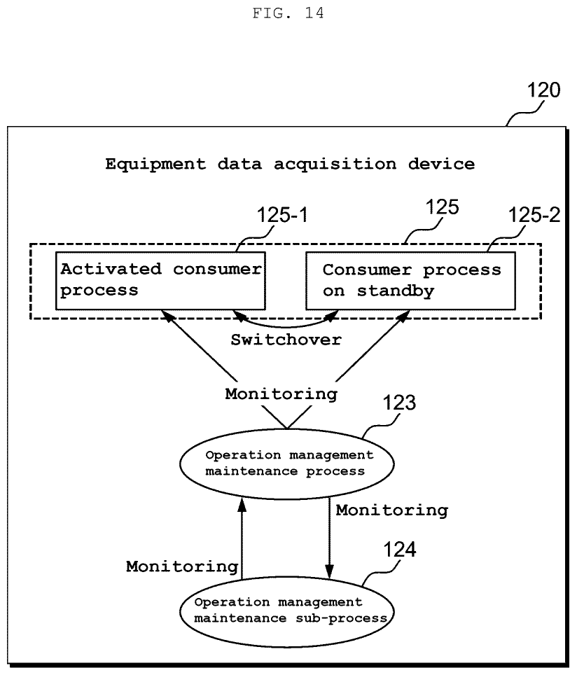

FIG. 14 is a diagram showing a structure of processes executed in an equipment data acquisition device according to one embodiment of the present disclosure.

Referring to FIG. 14, in the equipment data acquisition device 120 according to one embodiment of the present disclosure, processes to be monitored including an operation management maintenance process 123, an operation management maintenance sub-process 124, and a consumer process pair 125 may be executed.

An execution state of the £ operation management maintenance sub-process 124 may be monitored by the operation management maintenance process 123, and the operation management maintenance process 123 may be monitored by the operation management maintenance sub-process 124, and thus the operation management maintenance process 123 and the operation management maintenance sub-process 124 may have a structure of monitoring each other.

In addition, it may have a structure in which an execution state of the consumer process pair 125 is monitored by the operation management maintenance process 123, and an active state between the two consumer processes 125-1, 125-2 constituting the consumer process pair 125 is switched over.

When the execution state of the activated consumer process 125-1 is abnormal, the operation management maintenance process 123 may terminate the activated consumer process 125-1, and activate the consumer process on standby 125-2. In this case, the operation management maintenance process 123 may execute a new consumer process (not shown) in a standby state and manage the process by including it in the consumer process pair 125.

Here, the consumer process pair 125 may be a group consisting of two consumer processes 125-1, 125-2 that are set to have the same port address for acquiring data from semiconductor equipment, only one consumer process is activated at the same time between the consumer process pair, and the port address is actually occupied by the activated consumer process.

For example, only the first consumer process 125-1, which is one between the two consumer processes 125-1, 125-2 constituting the consumer process pair 125, is activated, and the second consumer process 125-2, which is the other one thereof, is on standby, and then a switch over may be performed in which the first consumer process 125-1 is deactivated and the second consumer process 125-2 is activated by the operation management maintenance process 123.

In this case, since the two consumer processes 125-1, 125-2 are set to have the same IP address and port address, the IP address and port address may be occupied by the first consumer process 125-1 prior to performing the switch over, and the IP address and port address may be occupied by the second consumer process 125-2 subsequent to performing the switch over.

Through this, the semiconductor equipment may transmit data without interruption while maintaining an EDA session with the IP address and port address set identically to the two consumer processes 125-1, 125-2 as the destination, and in the case of the equipment data acquisition device 120, data may be received from the semiconductor equipment without interruption.

Through this, the equipment data acquisition device 120 may provide a switch over function to ensure that a consumer process function, such as receiving data from specific semiconductor equipment, is not interrupted.

As an optional embodiment, the operation management maintenance process 123 may terminate the activated consumer process 125-1 and activate the consumer process 125-2 on standby as needed, even when the execution state of the activated consumer process 125-1 is not abnormal.

For example, when required to apply an update to a consumer process, the operation management maintenance process 123 may apply the update to the consumer process 125-2 on standby, then terminate the activated consumer process 125-1, and activate the consumer process 125-2 on standby, thereby allowing the update to be applied without interruption of the consumer process function, such as receiving data from semiconductor equipment.

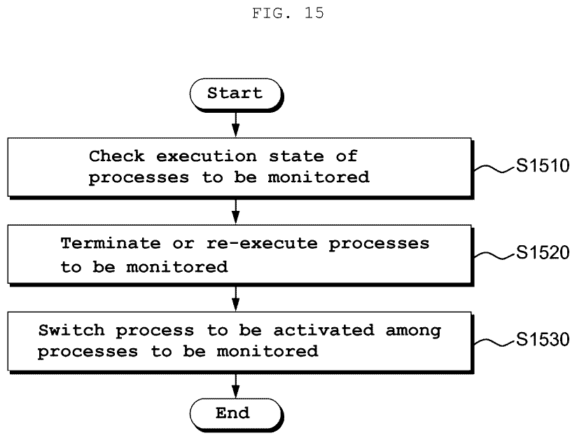

FIG. 15 is an operation flowchart showing a process switching method in an equipment data acquisition device according to one embodiment of the present disclosure.

Referring to FIG. 15, a process switching method in an equipment data acquisition device according to one embodiment of the present disclosure first allows the equipment data acquisition device to check an execution state of processes to be monitored through an operation management maintenance process (S1510).

Here, the processes to be monitored may include equipment data acquisition processes, that is, consumer processes.

As an optional embodiment, the processes to be monitored may include an operation management maintenance sub-process that is paired with the operation management maintenance process. The operation management maintenance sub-process may check an execution state of the operation management maintenance process, and terminate or re-execute the operation management maintenance process.

The equipment data acquisition device may check whether the execution state is normal based on whether the processes to be monitored respond within a reference time period or a state message received from the processes to be monitored.

Here, the equipment data acquisition device may determine that an execution state of a process to be monitored is abnormal when it receives a state message indicating an abnormal state, and furthermore, even when the process to be monitored is down or does not respond for a preset time period (hang or deadlock, etc.).

Next, the equipment data acquisition device may terminate or re-execute processes to be monitored to maintain the processes to be monitored in a state of being normally executed through an operation management maintenance process (S1520).

The equipment data acquisition device may terminate a process that is being executed but in an abnormal state. Additionally, the equipment data acquisition device may execute a process that is not being executed or has been terminated.

Next, the equipment data acquisition device may switch a process to be activated so as to allow a first process, which is one included in the processes to monitored, to be deactivated and a second process, which is another one thereof, to be activated through the operation management maintenance process (S1530).

Here, the equipment data acquisition device may check whether the processes to be monitored are activated through the operation management maintenance process, and activate a processes to be monitored that is not activated among the processes to be monitored.

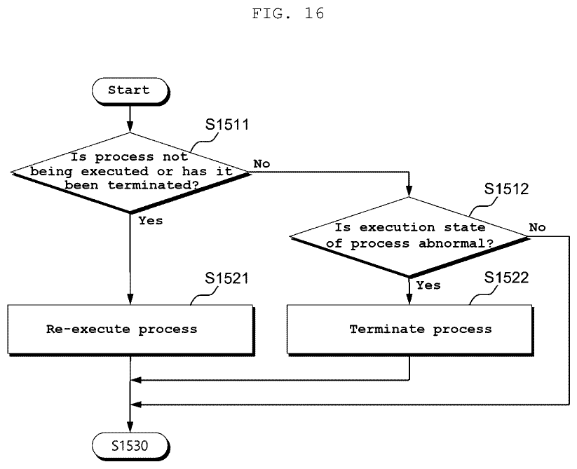

FIG. 16 is an operation flowchart showing a process switching method in an equipment data acquisition device according to another one embodiment of the present disclosure.

Referring to FIG. 16, a process switching method in an equipment data acquisition device according to another one embodiment of the present disclosure may first allow the equipment data acquisition device to check a process that is not being executed or has been terminated among processes to be monitored (S1511).

The equipment data acquisition device may re-execute a process that is not being executed or has been terminated among the processes to be monitored (S1521).

Next, the equipment data acquisition device may check a process with an abnormal execution state for processes that is being executed or has not be terminated among the processes to be monitored (S1512).

The equipment data acquisition device may terminate a process with an abnormal execution state among the processes to be monitored (S1522).

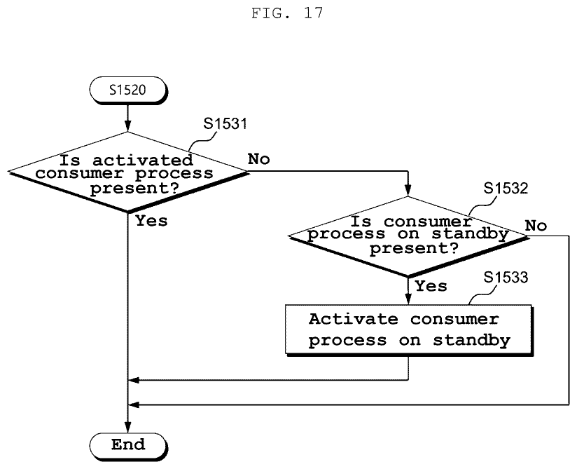

FIG. 17 is an operation flowchart showing a process switching method in an equipment data acquisition device according to still another one embodiment of the present disclosure.

Referring to FIG. 17, a process switching method in an equipment data acquisition device according to still another one embodiment of the present disclosure may first allow the equipment data acquisition device to check whether there is a consumer process activated in consumer process pair units included in the processes to be monitored through an operation management maintenance process (S1531).

Next, when there is no consumer process that is activated in one consumer process pairs, the equipment data acquisition device may check whether there is a consumer process that is not activated in the one of the consumer process pairs through the operation management maintenance process (S1532).

Next, the equipment data acquisition device may activate a consumer process that is not activated through the operation management maintenance process (S1533).

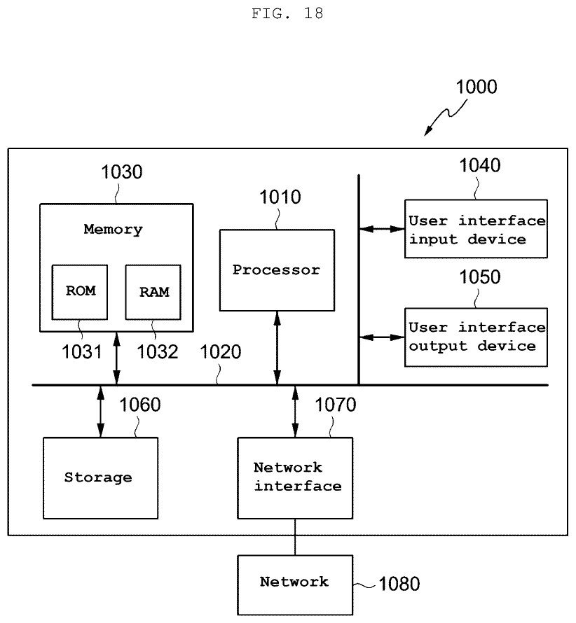

FIG. 18 showing a diagram showing an computer system according to one embodiment of the present disclosure.

The equipment data acquisition support device 110 or the equipment data acquisition device 120 of the present disclosure may be implemented in a computer system 1000 such as a computer-readable recording medium.

Referring to FIG. 18, the computer system 1000 may include one or more processors 1010, a memory 1030, a user interface input device 1040, a user interface output device 1050, and a storage 1060 that communicate with one another via a bus 1020. In addition, the computer system 1000 may further include a network interface 1070 connected to a network 1080. The processor 1010 may be a central processing unit or a semiconductor device that executes processing instructions stored in the memory 1030 or the storage 1060. The memory 1030 and the storage 1060 may be various types of volatile or non-volatile storage media. For example, the memory may include a ROM 1031 or a RAM 1032.

The specific implementations described in the present disclosure are embodiments, and do not limit the scope of the present disclosure in any way. For the sake of brevity of the specification, description of conventional electronic components, control systems, software, and other functional aspects of the systems may be omitted. Furthermore, connection lines or connection members between elements shown in the drawings, which are examples of functional connections and/or physical or circuital connections, may be represented by alternative or additional various functional connections, physical connections, or circuital connections in an actual device. In addition, unless an element is specifically described with the term such as “essential”, “important”, or the like, it may not be a necessary element for the application of the present disclosure.

Accordingly, the concept of the present disclosure should not be limited to the above-described embodiments, and the following claims as well as all equivalents or modifications thereof are intended to fall within the scope of the concept of the disclosure.

### DESCRIPTION OF SYMBOLS

110: Equipment data acquisition support device
111: Interface
112: Metadata management unit
113: Session management unit
114: Security management unit
115: Data collection plan management unit
120, 120-1, 120-2, 120-3: Equipment data acquisition device
121: Web application server
122: Message sequence guarantee support unit
123: Operation management maintenance process
124: Operation management maintenance sub-process
125, 125-1, 125-2: Equipment data acquisition process
130, 130-1, 130-2: User terminal
140: Equipment engineering system
150, 150-1, 150-2: Semiconductor equipment
160: Database
1000: Computer system
1010: Processor
1020: Bus
1030: Memory
1031: ROM
1032: RAM
1040: User interface input device
1050: User interface output device
1060: Storage
1070: Network interface
1080: Network

### INDUSTRIAL APPLICABILITY

The present disclosure relates to a SEMI standard-based equipment data acquisition support device therefor, and has industrial applicability in that it allows a user to manage an entire process of acquiring data from semiconductor equipment according to the SEMI standards.

1. An equipment data acquisition support device, the device comprising:
a plurality of interfaces comprising a first interface for receiving a command from a user terminal and responding to the received command, and a second interface for transmitting a command to semiconductor equipment and receiving a response according to the command according to the equipment data acquisition (EDA) standards;
a metadata management unit that provides access to metadata of the semiconductor equipment to the user terminal through the first interface;
a security management unit that provides access to an access control list (ACL) comprising access privilege information for the semiconductor equipment to the user terminal through the first interface;
a session management unit that provides a session connection based on the access control list to the user terminal through the first interface; and
a data collection plan management unit that provides access to a data collection plan (DCP) of the semiconductor equipment defined based on the metadata to the user terminal through the first interface.

2. The device of claim 1, wherein the session management unit registers the semiconductor equipment in an equipment list based on an access address for the semiconductor equipment received from the user terminal through the first interface,
wherein the metadata management unit receives metadata from the semiconductor equipment registered in the equipment list through the second interface, and
wherein the session management unit maps an access address of a consumer server to be provided with an EDA client service to the semiconductor equipment that has received the metadata.

3. The device of claim 2, wherein the consumer server is a server physically separated from the equipment data acquisition support device, and
wherein the access address of the consumer server is a different access address from that of the equipment data acquisition support device.

4. The device of claim 2, wherein the session management unit synchronizes the access address of the consumer server mapped to the semiconductor equipment through the second interface with an active state of the data collection plan defined for the semiconductor equipment.

5. The device of claim 4, wherein the active state of the data collection plan is maintained independently of a connection state between the semiconductor equipment and the equipment data acquisition support device.

6. An equipment data acquisition method, the method comprising:
adding, by an equipment data acquisition support device, an access control list comprising access privilege information for semiconductor equipment;
connecting, by the equipment data acquisition support device, a session for the semiconductor equipment based on an item corresponding to a user of a user terminal among items included in the access control list;
loading, by the equipment data acquisition support device, metadata of the semiconductor equipment connected to the session;
creating, by the equipment data acquisition support device, a data collection plan of the semiconductor equipment based on the loaded metadata; and
activating, by the equipment data acquisition support device, the created data collection plan.

7. he method of claim 6, further comprising:
prior to adding the access control list,
registering, by the equipment data acquisition support device, other users to access the equipment data acquisition support device based on information on other users received from the user terminal;
registering, by the equipment data acquisition support device, semiconductor equipment to be managed by the equipment data acquisition support device based on a semiconductor equipment access address that has received from the user terminal; and
registering, by the equipment data acquisition support device, consumer servers to collect data from the semiconductor equipment based on a consumer server access address that has received from the user terminal.

8. The method of claim 6, wherein the loading of the metadata comprises:
receiving, by the equipment data acquisition support device, a list of existing data collection plans defined in semiconductor equipment connected to the session, and wherein the creating of the data collection plan comprises:
creating, by the equipment data acquisition support device, a new data collection plan based on the metadata and the existing data collection plans, the method further comprising:
subsequent to creating the data collection plan,
receiving, by the equipment data acquisition support device, a real-time parameter value corresponding to the new data collection plan.

9. The method of claim 8, further comprising:
subsequent to activating the data collection plan, redefining, by the equipment data acquisition support device, the data collection plan of the semiconductor equipment into the new data collection plan; and
synchronizing, by the equipment data acquisition support device, an active state of the new data collection plan defined in the semiconductor equipment.

10. An equipment data acquisition support device, the device comprising:
a memory in which at least one program is recorded; and
a central processing unit (CPU) that executes the program,
wherein the program comprises instructions to perform the operations of:
adding an access control list comprising access privilege information for semiconductor equipment;
connecting a session to the semiconductor equipment based on an item corresponding to a user of the user terminal among items included in the access control list;
loading metadata of the semiconductor equipment connected to the session;
creating a data collection plan of the semiconductor equipment based on the loaded metadata; and
activating the created data collection plan.

11. canceled
